(19) United States
(12) Patent Application Publication
(10) Pub. No.: US 2015/0234323 A1
(43) Pub. Date: Aug. 20, 2015

(54) DEVELOPING APPARATUS

(71) Applicant: CANON KABUSHIKI KAISHA, Tokyo (JP)

(72) Inventors: Mitsuhiro Furukawa, Kawaguchi-shi (JP); Masanori Akita, Toride-shi (JP)

(21) Appl. No.: 14/624,678

(22) Filed: Feb. 18, 2015

(30) Foreign Application Priority Data
Feb. 20, 2014 (JP) 2014-030599

(51) Int. Cl. G03G 15/09

(52) U.S. Cl. CPC G03G 15/0891

(57) ABSTRACT

A developing apparatus includes a second chamber configured to communicate with the first chamber and to collect the developer from the developer carrier, an agitating conveyor screw provided in a first chamber and configured to convey the developer in the first chamber while agitating the developer, and a guide member disposed above the agitating conveyor screw in the first chamber. The agitating conveyor screw has an agitating blade spirally extending in the axial direction and the guide member is configured to guide a developer thrown upward by the rotating agitating conveyor screw toward the layer thickness limiting member.

### BACKGROUND OF THE INVENTION

1. Field of the Invention

This disclosure relates a developing apparatus.

2. Description of the Related Art

There is widely used an image forming apparatus equipped with a developing apparatus of a two component development system that develops an electrostatic image (electrostatic latent image) formed on an image carrier (for example, a photoconductive drum) into a toner image by using a developer containing non-magnetic toner and magnetic carriers. There may be a developing apparatus of a two component development system that circulates a two component developer while agitating the two component developer using a pair of conveyor screws longitudinally disposed in a developing case with a partition wall interposed between the pair of conveyor screws.

In this developing apparatus, since a new non-magnetic toner is supplied along with the consumption of the non-magnetic toner, and old magnetic carriers are continuously circulated in the developing case, the charging properties of the two component developer deteriorate gradually. For this reason, many developing apparatuses adopt a so-called trickle configuration in which the magnetic carriers are discharged little by little from the developing case, and the developing case is refilled with a refill developer having new carriers mixed therein, and the magnetic carriers in the developing case are also replaced with new ones, and thereby the charging properties of the magnetic carriers in the developing case are maintained constant.

More specifically, for example, the developing apparatus using the two component developer may include the following configuration. That is, the developing apparatus may include the developing case for accommodating the developer, and include a developing sleeve at an opening portion formed at a position in the developing case in such a manner so as to face the photoconductive drum. A development chamber and an agitation chamber partitioned by a partition wall are disposed on the opposite side of the opening portion in the developing case, and are respectively positioned on upper and lower sides in a vertical direction. A first conveyor screw and a second conveyor screw are respectively disposed in the development chamber and the agitation chamber, and agitate, convey, and circulate the developer in the developing case.

The first conveyor screw conveys the developer in the developing case while agitating the developer, the second conveyor screw conveys the developer while agitating the toner refilled into the agitation chamber via a toner refill port and the developer already in the agitation chamber, and thereby the concentration of the toner in the developer is homogenized. The developing sleeve is rotatably disposed at a position in the developing case in such a manner so as to face the photoconductive drum. A magnet is built into the developing sleeve, and a limiting blade is disposed in such a manner so as to face the developing sleeve, with a predetermined gap interposed between the limiting blade and an outer peripheral surface of the developing sleeve. Accordingly, it is possible to uniformly coat the surface of the developing sleeve with the developer, and to convey the developer to a development region. The gap between the developing sleeve and the limiting blade is adjusted in such a manner that the developer can be uniformly and stably supplied to the development region.

In the developing apparatus, since the developer supplied to the developing sleeve from the first conveyor screw does not return to the development chamber directly, and is collected in the agitation chamber, a developer level in the development chamber tends to be decreased toward a downstream side in a direction of conveyance. For this reason, typically, in a downstream portion of the first conveyor screw, the amount of developer tends to be excessively small, and the amount of supply of the developer to the developing sleeve from the first conveyor screw also tends to be decreased. In this state, the amount of supply of the developer to the developing sleeve deviates in a longitudinal direction, there is an occurrence of variation in the amount of coating on the surface of the developing sleeve, and as a result, a variation in the density of a formed image may occur in the longitudinal direction.

In the related art, a technology is proposed as a countermeasure against this problem in Japanese Patent Application Laid-open No. H05-333691, by which the amount of conveyance of the developer by the first and second conveyor screws is much greater than the amount of supply of developer to the developing sleeve, and the amount of the developer is prevented from being decreased in the downstream portion of the first conveyor screw.

In this developing apparatus, typically, the first conveyor screw rotates in a clockwise direction so that the developer can be easily supplied to the developing sleeve therefrom. As a result, the developer in contact with the first conveyor screw receives a force in the direction of conveyance, and the developer on a side close to the developing sleeve receives a perpendicular upward force. In contrast, the developer on a side distant from the developing sleeve receives a perpendicular downward force. Therefore, the level of the developer on the side close to the developing sleeve is high. As a result, even though the amount of developer is excessively small, the developer is biased in a region close to the developing sleeve, and thereby it is possible to prevent the developer from being poorly supplied to the developing sleeve.

However, the technology in the related art described above as a countermeasure has the following problem. That is, in the technology disclosed in Japanese Patent Application Laid-open No. H05-333691, it is necessary to increase a conveying force of each of the first and second conveyor screws to be higher than that required to supply the developer to the developing sleeve. When the conveyor screws excessively convey the developer, there is occurrence of new problems, for example, an increase in the stress of the developer, or the sticking of toner due to heat generated from a screw sliding portion.

When the first conveyor screw rotates in the clockwise direction, the developer is inclined in such a manner that the level of the developer on the side close to the developing sleeve is high, and the developer is thrown perpendicularly upward. Most of thrown-upward developer falls on the first conveyor screw as is, and does not contribute to the supply of the developer to the developing sleeve. Accordingly, there is room for improvement in efficiently supplying the developer to the developing sleeve.

### SUMMARY OF THE INVENTION

According to an aspect of this disclosure, there is provided a developing apparatus including a developer carrier configured to rotate while carrying a developer containing toner and carriers, a first chamber configured to supply the developer to the developer carrier, a layer thickness limiting member configured to limit the layer thickness of the developer supplied from the first chamber and carried by the developer carrier, a second chamber configured to communicate with the first chamber and to collect the developer from the developer carrier, an agitating conveyor screw provided parallely with the developer carrier in the first chamber such that an axial direction of a rotation shaft of the agitating conveyor screw is parallel to a rotation shaft of the developer carrier and a position of the agitating conveyor screw is shifted from that of the developer carrier in a width direction orthogonal to the axial direction, the agitating conveyor screw includes an agitating blade spirally extending in the axial direction to convey the developer in the axial direction while agitating the developer in the first chamber, and a guide member disposed above the agitating conveyor screw in the first chamber and configured to guide a developer thrown by the rotating agitating conveyor screw toward the layer thickness limiting member.

Further features of the present invention will become apparent from the following description of exemplary embodiments with reference to the attached drawings. The accompanying drawings, which are incorporated in and constitute apart of the specification, illustrate exemplary embodiments, features, and aspects of the invention and, together with the description, serve to explain the principles of the invention.

### BRIEF DESCRIPTION OF THE DRAWINGS

FIG. 1 is a schematic view illustrating an image forming apparatus according to a first embodiment.

FIG. 2 is an enlarged cross-sectional view illustrating a developing apparatus according to the first embodiment.

FIG. 3 is a view illustrating a development chamber and an agitation chamber of the developing apparatus according to the first embodiment, in which a guide member is omitted.

FIG. 4 is an enlarged cross-sectional view illustrating the developing apparatus according to the first embodiment.

FIG. 5 is a view illustrating the developing apparatus, particularly, a circulation portion according to the first embodiment.

FIG. 6 is a view illustrating the motion of an agitating blade and a developer in the developing apparatus according to the first embodiment.

FIG. 7 is a cross-sectional view illustrating a relationship between the motion of a flown-off developer and the guide member in the developing apparatus according to the first embodiment.

FIG. 8 is a cross-sectional view illustrating a relationship between the motion of a flown-off developer and the guide member in the developing apparatus according to the first embodiment.

FIG. 9 is a view illustrating a developing apparatus, particularly, a circulation portion according to a second embodiment of this disclosure.

FIG. 10 is a view illustrating the developing apparatus, particularly, the shape of a guide member according to the second embodiment.

FIG. 11 is a view illustrating a developing apparatus, particularly, a circulation portion according to a third embodiment of this disclosure.

FIG. 12 is a cross-sectional view illustrating the developing apparatus according to the third embodiment.

FIG. 13 is a cross-sectional view illustrating a developing apparatus according to a fourth embodiment of this disclosure.

FIG. 14 is a view illustrating the developing apparatus, particularly, a circulation portion according to the fourth embodiment.

FIG. 15 is a cross-sectional view particularly illustrating the motion of a flown-off developer in an example of a configuration in which a first conveyor screw rotates in a counter-clockwise direction and the guide member is not provided.

FIG. 16 is a cross-sectional view particularly illustrating a relationship between the motion of the flown-off developer and the guide member in an example of a configuration that is obtained by adding the guide member to the configuration illustrated in FIG. 15.

FIG. 17A is a view illustrating Modification Example 1 in which a part of the fourth embodiment is modified.

FIG. 17B is an enlarged cross-sectional view illustrating a development chamber and the like of a developing apparatus in Modification Example 1.

FIG. 18 is a view illustrating Modification Example 2 in which a rib member of the third embodiment is added to the configuration of the fourth embodiment.

FIG. 19 is an enlarged cross-sectional view illustrating a development chamber and the like of a developing apparatus in Modification Example 2.

### DESCRIPTION OF THE EMBODIMENTS

### First Embodiment

Hereinafter, an image forming apparatus with a developing apparatus according to an embodiment will be described with reference to the accompanying drawings. It is noted that, for example, the developing apparatus is used in the image forming apparatus which will be described below; however, the use of the developing apparatus is not necessarily limited to the image forming apparatus. In the embodiment, the description will mainly focus on the formation, transfer, and development of a toner image; however, this disclosure can be added with an apparatus, equipment, and a housing structure, and can be put into practice in various use cases, for example, a printer, various printing machines, a coping machine, a FAX, and a multi-purpose peripheral.

### <Outline of Imaging Forming Apparatus>

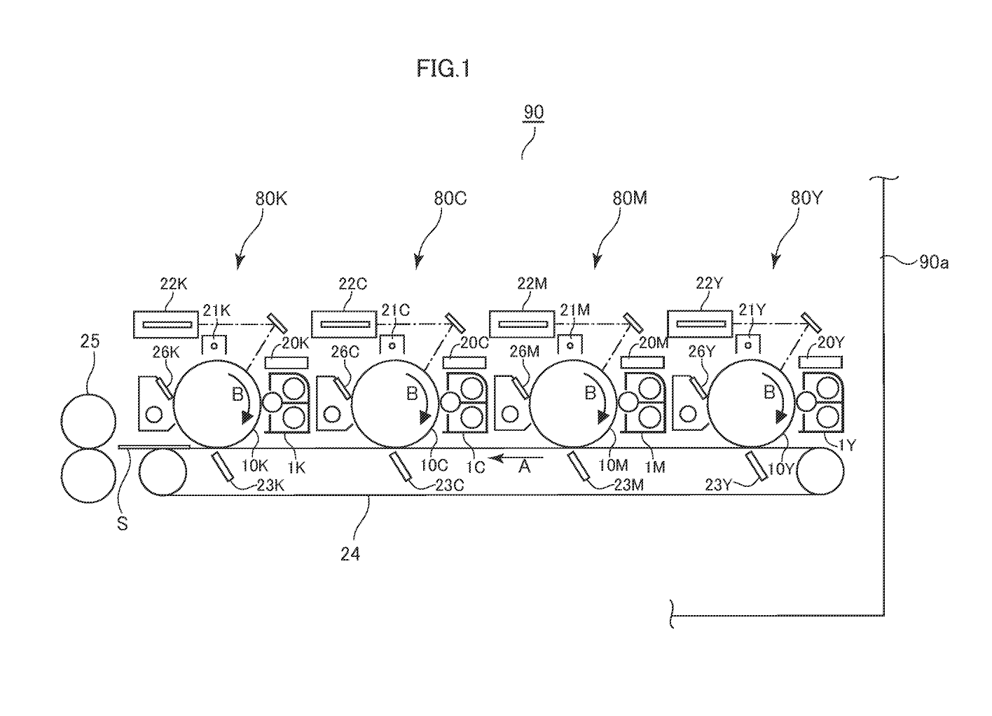

FIG. 1 is a schematic view illustrating the configuration of an image forming apparatus 90 according to the embodiment. As illustrated in FIG. 1, the image forming apparatus 90 has an apparatus main body 90a. The image forming apparatus 90 is a full color printer having the following configuration elements inside the apparatus main body 90a: a recording medium conveyor belt 24 rotatable in a direction of arrow A; and image forming portions (stations) 80Y, 80M, 80C, and 80K sequentially disposed along an upward-facing surface of the recording medium conveyor belt 24.

The image forming portions 80Y, 80M, 80C, and 80K have substantially the same configuration, and form yellow (Y), magenta (M), cyan (C), and black (K) images in a full color image, respectively. In the following description, a developing apparatus 1 collectively indicates respective developing apparatuses 1Y, 1M, 1C, and 1K of the image forming portions 80Y, 80M, 80C, and 80K which correspond to yellow, magenta, cyan, and black colors, respectively.

Similarly, this also applies to other configuration portions.

Here, an operation of the entirety of the image forming apparatus 90 will be described. A photoconductive drum 10 as an image carrier is disposed in such a manner as to be able to rotate in a direction of arrow B. In the image forming apparatus 90, the photoconductive drum 10 is equally charged by a primary charger 21, and is exposed to light from a light emitting diode 22 such as a laser and modulated in response to information signals, and thereby a latent image (electrostatic latent image) is formed on the photoconductive drum 10. The developing apparatus 1 turns the latent image into a visible image as a developed image (toner image) in the processes described below. A first transfer charger 23 sequentially transfers the toner image on a recording medium S in each of the image forming portions 80Y, 80M, 80C, and 80K, the recording medium S being conveyed by the recording medium conveyor belt 24 rotating in the direction of arrow A. A fixing unit 25 fixes the toner image transferred on the recording medium S, and thereby an image is obtained.

Residual toner on the photoconductive drum 10 is removed by a cleaning unit 26. When the toner in a developer is consumed during the image formation, toner is refilled from a toner refill container 20. Here, a method is adopted by which the photoconductive drums 10M to 10K directly transfer the toner images on the recording medium S conveyed by the recording medium conveyor belt 24; however, other methods can be adopted. That is, similarly, this disclosure can also be applied to an image forming apparatus in which an intermediate transfer body such as an intermediate transfer belt is disposed instead of the recording medium conveyor belt 24, and colors of toner images are primarily transferred to the intermediate transfer body from the photoconductive drums 10Y to 10K, and then colors of composite toner images are secondarily and collectively transferred to a recording medium.

### <Description of Two Component Developer>

Subsequently, a two component developer used in the embodiment will be described. Toner includes binder resin, and a coloring agent, and as necessary, further includes coloring resin particles containing other additives, and coloring particles (for example, colloidal silica fine particles) having an external additive externally added thereto. The toner is polyester resin having negative charge properties, and the toner used in the embodiment has a volumetric mean particle size of 7.0 μm.

The following materials can be suitably used for a carrier: surface oxidized or non-oxidized steel; metal such as nickel, cobalt, manganese, chromium, and rare earths; an alloy thereof; and oxide ferrite. A method of manufacturing magnetic particles of the carrier is not particularly limited.

### <Developing Apparatus>

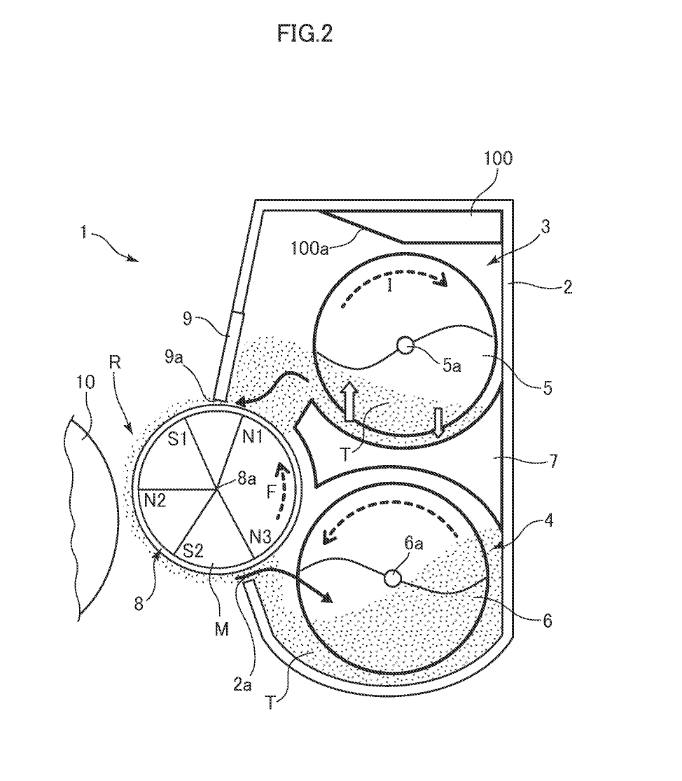

Subsequently, the developing apparatus 1 (1Y, 1M, 1C, and 1K) will be described with reference to FIG. 2.

As illustrated in FIG. 2, the developing apparatus 1 has a developing case 2 having an opening portion 2a at a position that faces the photoconductive drum 10 (10Y, 10M, 10C, and 10K). The developing case 2 accommodates a two component developer containing non-magnetic toner and magnetic carriers.

The developing apparatus 1 has a developing sleeve 8 in the developing case 2, and the developing sleeve 8 as a developer carrier is disposed in such a manner as to protrude toward the photoconductive drum 10 via the opening portion 2a. The developing sleeve (developer carrier) 8 rotates while carrying a two component developer (hereinafter, also referred to as a developer) T containing non-magnetic toner (toner) and magnetic carriers (carriers).

A limiting blade 9 is disposed in an upper portion of the opening portion 2a of the developing case 2 in a state where a distal end portion 9a of the limiting blade 9 is separated from the developing sleeve 8 by a predetermined gap, and the limiting blade 9 limits the layer thickness of the developer carried on the surface of the developing sleeve. It is noted that the limiting blade 9 forms a layer thickness limiting member limiting the layer thickness of the developer T that is supplied from a development chamber 3 and is carried by the developing sleeve 8.

The developing case 2 has a partition wall 7 at a substantially center portion thereof in a vertical direction in FIG. 2, and the partition wall extends in a forward and backward direction with respect to the drawing sheet of FIG. 2. The partition wall 7 partitions the developing case 2 into an upper development chamber 3 and a lower agitation chamber 4. The two component developer T is accommodated in the development chamber 3 and the agitation chamber 4.

A first conveyor screw 5 and a second conveyor screw 6 are respectively disposed in the development chamber 3 and the agitation chamber 4, and agitate, convey, and circulate the two component developer (developer) T in the developing case 2. The development chamber 3 and the agitation chamber 4 are respectively disposed on upper and lower sides in the vertical direction, and the developing sleeve 8 is disposed in such a manner that a center of rotation (rotation shaft) 8a of the developing sleeve 8 is positioned below than a center of rotation (a rotation shaft 5a) of the first conveyor screw 5 in the vertical direction.

It is noted that the development chamber 3 forms a first chamber for supplying the developer T to the developing sleeve (developer carrier) 8. The agitation chamber 4 forms a second chamber that communicates with the development chamber 3 and collects the developer T from the developing sleeve 8. The first conveyor screw 5 forms an agitating conveyor screw that is disposed in the development chamber (the first chamber) 3, agitates and conveys the developer T in the development chamber 3 (in the first chamber), and includes a continuously spiraling agitating blade 5b.

The first conveyor screw 5 is disposed in a bottom portion of the development chamber 3 in such a manner as to be parallel to the developing sleeve 8 along an axial direction of the developing sleeve 8, and the first conveyor screw 5 conveys the developer T in the development chamber 3 in one direction (in a backward direction in FIG. 2) along the axial direction by rotating in a clockwise direction (direction of arrow I) in FIG. 2. The second conveyor screw 6 is disposed in a bottom portion of the agitation chamber 4 in such a manner as to be parallel to the shaft of the first conveyor screw 5, and the second conveyor screw 6 conveys the developer T in the agitation chamber 4 in the opposite direction (in a forward direction in FIG. 2) of the conveying direction of the first conveyor screw 5 by rotating in a counter-clockwise direction as illustrated in FIG. 2. That is, the partition wall 7 partitions an inner space of the developing case 2 into an upper region and a lower region in the vertical direction, the first conveyor screw (supply conveyor screw) 5 is provided above the partition wall 7, and the second conveyor screw (circulating conveyor screw) 6 is provided below the first conveyor screw 5 with the partition wall being interposed therebetween. The first conveyor screw 5 is provided in such that the axial direction of the rotation shaft 5a is parallel to the rotation shaft 8a of the developing sleeve 8, and the first conveyor screw 5 is provided parallely with the developing sleeve 8 in a width direction (lateral direction) orthogonal to the axial direction. The developing apparatus 1 is configured such that the developer is supplied to the developing sleeve 8 and is conveyed in the axial direction by the agitating blade 5b rotating and extending in the axial direction. The second conveyor screw 6 is provided in such a manner that an axial direction of a rotation shaft 6a of the second conveyor screw 6 is parallel to the rotation shaft of the first conveyor screw 5, and the second conveyor screw 6 collects and circulates the developer that is conveyed by the first conveyor screw 5 and falls downward. It is noted that in the embodiment, the term “parallel” implies that there is not necessarily perfect parallelity present therebetween and may be substantial parallelity present therebetween.

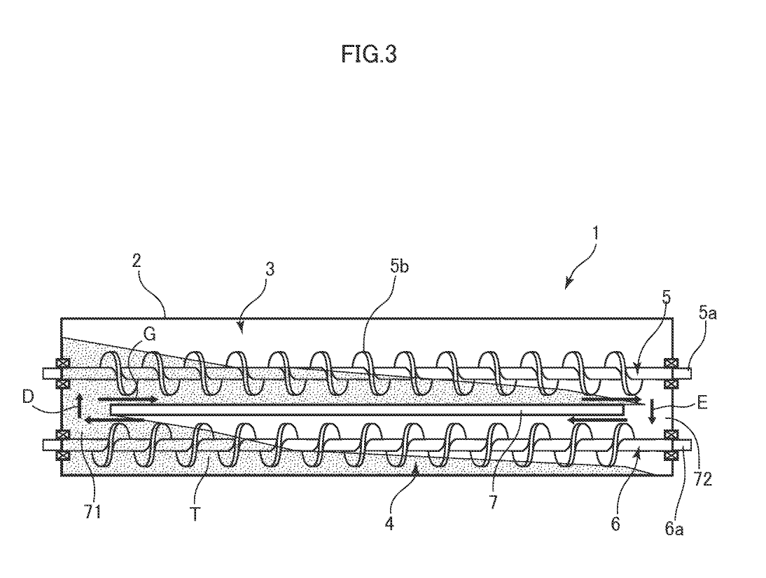

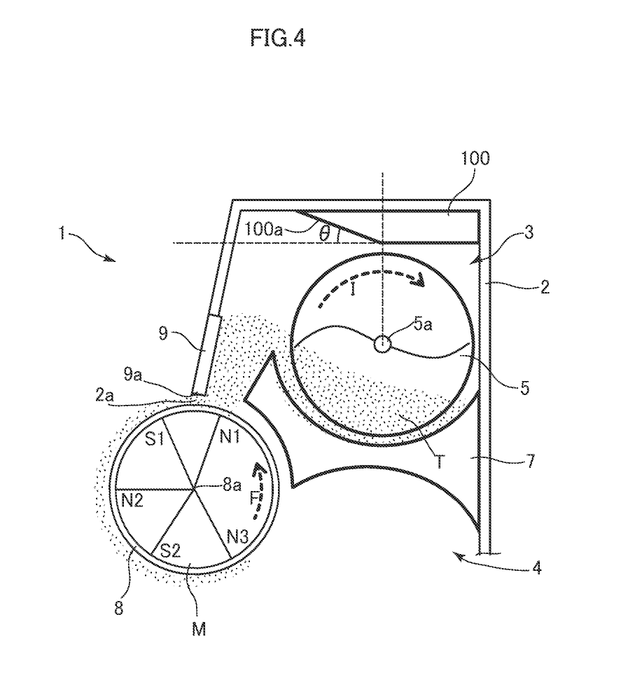

The developer T conveyed by the rotation of the first conveyor screw 5 and the second conveyor screw 6 is circulated between the development chamber 3 and the agitation chamber 4 in a direction of each of arrows D and E (refer to FIG. 3) via communicating portions 71 and 72 (refer to FIG. 3) provided in longitudinal opposite end portions of the partition wall 7. The developer T is supplied to the development chamber 3 via the communicating portion 71 between the developing sleeve 8 and the partition wall 7. It is noted that for illustrative purposes, a guide member 100 illustrated in FIGS. 2 and 4 is omitted from FIG. 3.

Each of the first conveyor screw 5 and the second conveyor screw 6 has a screw structure in which a non-magnetic agitating blade is spirally provided on an outer circumference of each of the respective rotation shafts 5a and 6a. The screw diameter of each of the first conveyor screw 5 and the second conveyor screw 6 is set to be φ 20 mm in the entire range thereof, a screw pitch is set to be 30 mm, and a rotation speed is set to be 600 rpm. As described above, the developing case 2 has the opening portion 2a provided at a position equivalent to a development region R that faces the photoconductive drum 10. The developing sleeve 8 is rotatably supported in such a manner that a part of an outer circumference of the developing sleeve 8 is exposed to the outside of the container from the opening portion 2a in the side of the photoconductive drum 10.

The developing sleeve 8 is made of a non-magnetic material, and a magnetic roller M (that is, a magnetic field generating unit) in a non-rotating state is installed in the developing sleeve 8. As illustrated in FIG. 2, the magnetic roller M has a developed image pole S2, and magnetic poles S1, N1, N2, and N3 for conveying the developer. Among these poles, a first magnetic pole N3 and a second magnetic pole N1 having the same polarity are configured such that the first magnetic pole N3 and the second magnetic pole N1 are installed on an inner side of the developing case 2 while being adjacent to each other, and a repulsive magnetic field is formed between these poles, and thereby it is possible to separate the developer from the surface of the developing sleeve in the agitation chamber 4.

In a development operation, the developing sleeve 8 having the above-mentioned configuration rotates in a direction of arrow F in FIG. 2, and carries the developer T, the layer thickness of which is limited due to the ear cutting of magnetic brush by the limiting blade 9. The carried developer T is conveyed to the development region R facing the photoconductive drum 10, and is supplied to an electrostatic latent image formed on the photoconductive drum 10, and the latent image is developed. The limiting blade 9 is formed of a plate-like non-magnetic member (made of aluminum or the like) extending along a longitudinal axial line of the developing sleeve 8, and is provided on an upstream side of the photoconductive drum 10 in the rotation direction of the developing sleeve.

Both of the non-magnetic toner and the magnetic carrier of the two component developer T are sent to the development region R while passing through the gap between the distal end portion 9a of the limiting blade 9 and the developing sleeve 8. The amount of ear cutting of the magnetic brush of the developer carried by the developing sleeve 8 is limited, and the amount of developer conveyed to the development region R is adjusted, by adjusting the gap between the limiting blade 9 and the surface of the developing sleeve. It is noted that in the embodiment, for example, the amount of coating of the developer per unit area on the developing sleeve 8 is limited to 30 mg/cm² by the limiting blade 9.

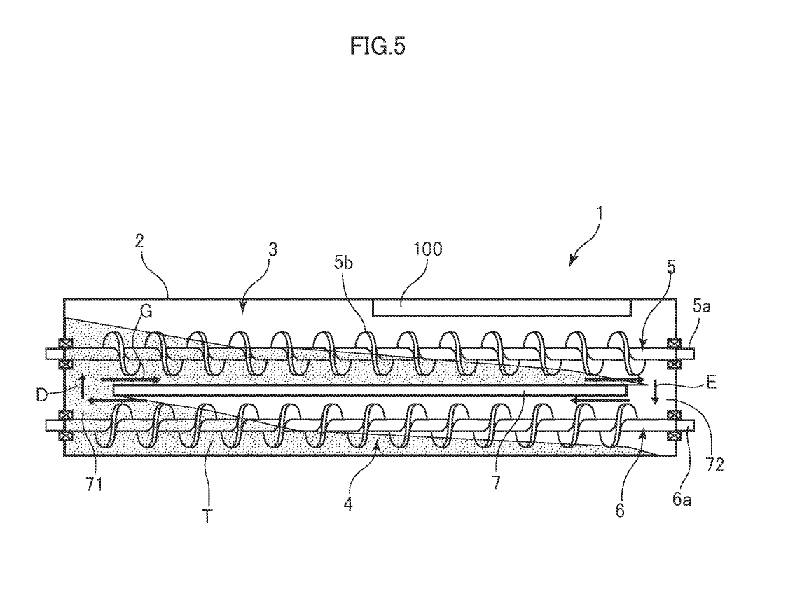

Subsequently, in the embodiment, the guide member 100 disposed above the first conveyor screw 5 will be described with reference to FIGS. 4 and 5.

As illustrated in FIG. 4, in the configuration of the embodiment, the rotation direction of the first conveyor screw (agitating conveyor screw) 5 is opposite to the rotation direction of the developing sleeve (developer carrier) 8. In other words, in the embodiment, the first conveyor screw 5 is configured to rotate in a direction in which the developer is thrown (scraped) upward on the side of the developing sleeve in the width direction. The guide member (a guide made of resin) 100 is provided in such a manner that an inclined guide surface 100a is disposed so as to face in a direction of the limiting blade 9 from an upper position perpendicular to the rotation shaft (the center of rotation) 5a of the first conveyor screw 5.

The guide member 100 has the inclined guide surface 100a inclined gradually upward to face in the direction of the limiting blade 9. The guide member 100 is configured to rebound and guide the developer T thrown (splashed) upward by the rotating first conveyor screw 5 toward the limiting blade 9 by the inclined guide surface 100a. That is, the inclined guide surface (an inclined surface) 100a is inclined such that the thickness thereof is decreased from the first conveyor screw 5 side toward the developing sleeve 8 side in the width direction. More specifically, the inclined guide surface 100a is inclined by an angle θ from a position in the horizontal direction in FIG. 4 in the guide member 100, the position corresponding to the rotation shaft 5a of the first conveyor screw 5, and the inclined guide surface 100a moves further upward while approaching the limiting blade 9.

In the embodiment, the guide member 100 is provided in a region on a side opposite to the developing sleeve 8 in the width direction across the position of an widthwise end portion, close to the developing sleeve 8, of the first conveyor screw 5. The inclined guide surface 100a is inclined from a position on a side of the liming blade (layer thickness limiting member) 9 across a position above the center of rotation (the rotation shaft 5a) of the first conveyor screw 5 toward the limiting blade 9. That is, the inclined guide surface 100a is preferably provided on the side of the developing sleeve 8 across the rotation shaft 5a of the first conveyor screw 5 in the width direction. The guide member 100 is disposed in the upper vicinity of the first conveyor screw 5 in the development chamber 3, and the developer T thrown upward by the rotating first conveyor screw 5 is guided toward the limiting blade 9 by the guide member 100.

As illustrated in FIG. 5, the guide member 100 is formed in such a manner as to extend in a depth direction (longitudinal direction) of the developing apparatus 1, and the longitudinal disposition position of the guide member 100 is located on a downstream side in a direction of conveyance (in a direction of arrow G) of the first conveyor screw 5. In the embodiment, the inclined angle θ of the inclined guide surface 100a is set to be 20°.

Hereinafter, the effects of using the guide member 100 will be described in detail. First, a technical background on the rotating of the first conveyor screw 5 in the clockwise direction (in the direction of arrow I) in FIG. 4 will be described.

In the embodiment, the first conveyor screw 5 rotates in the clockwise direction as illustrated in FIG. 4 so that the developer can be efficiently supplied to the developing sleeve 8 from the first conveyor screw (agitating conveyor screw) 5. During this rotation, the developer T in contact with the first conveyor screw 5 receives a conveying force in a normal direction to a screw surface.

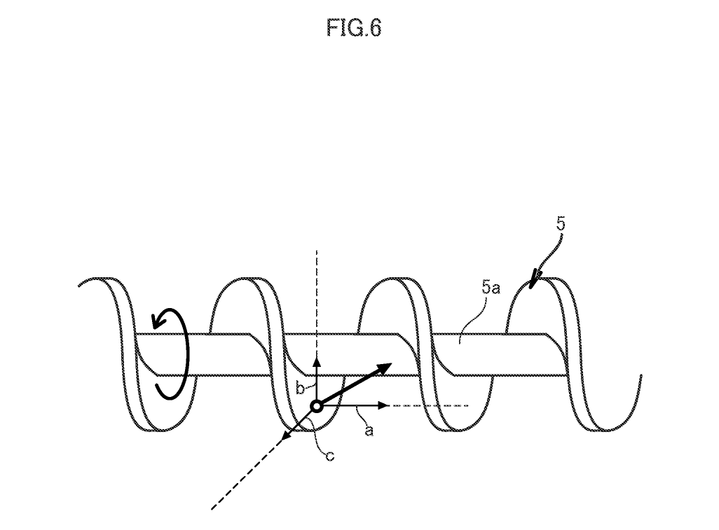

That is, as illustrated in FIG. 6, the developer in contact with the first conveyor screw 5 in the vicinity of the developing sleeve receives a component force in each of the following directions: direction of conveyance of the developer (direction of arrow (a) in FIG. 6); perpendicular upward direction (direction of arrow (b) in FIG. 6); and direction approaching the developing sleeve (direction of arrow (c) in FIG. 6). In contrast, the developer distant from the developing sleeve receives a component force in each of the direction of conveyance of the developer (the direction of arrow (a) in FIG. 6) and in a perpendicular downward direction.

As a result, since the developer T is biased in the development chamber 3 in such a manner that the level of the developer T close to the developing sleeve is high when seen in a cross-sectional direction of the drawing sheet in FIG. 4, even when there is a small amount of the developer present, it is easy to supply the developer to the developing sleeve 8. This is the reason why the first conveyor screw 5 rotates in the clockwise direction.

However, when the first conveyor screw 5 rotates in the clockwise direction, the distribution of the developer is inclined in such a manner that the level of the developer close to the developing sleeve is high, and a part of the developer is thrown perpendicularly upward. In a developing apparatus in the related art, when the thrown-upward and flown-off developer falls on apart (in the embodiment, equivalent to the agitating blade 5b of the first conveyor screw 5) of the developing sleeve as is, and thereby the thrown-upward and flown-off developer cannot be supplied to the developing sleeve 8.

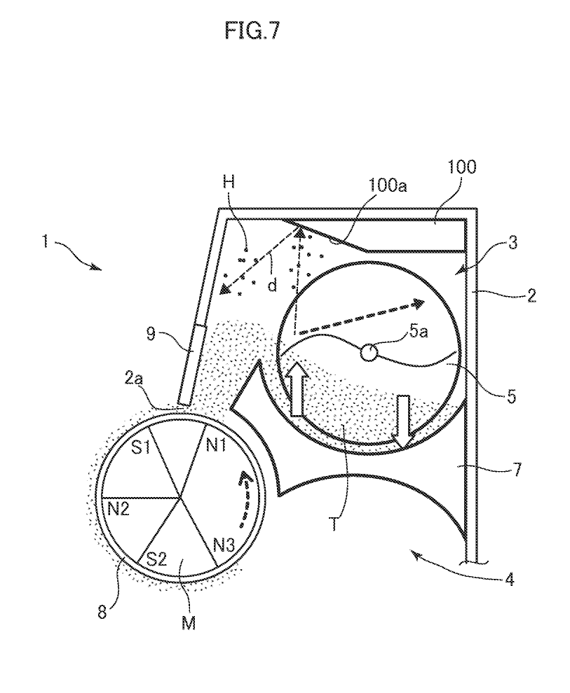

In the embodiment, the guide member 100 is disposed such that the inclined guide surface 100a faces in the direction of the limiting blade 9 on the upper position perpendicular to the first conveyor screw 5 and on the side close to the limiting blade 9 with respect to the position of the center of the first conveyor screw 5. As a result, as illustrated in FIG. 7, when a flown-off developer H thrown upward due to the rotation of the first conveyor screw 5 collides with and is reflected by the inclined guide surface 100a, thereby the developer H is guided to a direction of the developing sleeve 8 (in the direction of arrow (d)). For this reason, the part of the developer T can be supplied to the developing sleeve 8.

Subsequently, in the embodiment, a technical background will be described, on which as illustrated in FIG. 5, the guide member 100 is formed from a center region to a downstream side in the direction (in the direction of arrow G) in which the developer is conveyed by the first conveyor screw 5.

As repeatedly described, in the development chamber 3, while being supplied to the developing sleeve 8, the developer T is conveyed to the downstream side in the direction (in the direction of arrow G in FIG. 5) in which the developer is conveyed by the first conveyor screw 5, and thereby the amount of developer tends to inevitably decrease from an upstream side to the downstream side in the direction of conveyance. For the same reason, when the amount of conveyance (the amount of supply) of the developer to the developing sleeve 8 is further increased on the upstream side in the direction of conveyance, the amount of developer tends to be further decreased, and thereby the amount of developer becomes further insufficient on the downstream side in the direction of conveyance.

Accordingly, the guide member 100 does not preferably supply the developer T more than necessary to the developing sleeve 8 on the upstream side in the direction of conveyance because the supply of the developer is decreased on the downstream side. Since the amount of developer is considerable on the upstream side in the direction of conveyance, the amount of developer required to stably coat the surface of the developing sleeve 8 is ensured.

For the above-mentioned reason, in the embodiment, the guide member 100 is disposed from the center region to the downstream side in the direction of conveyance of the developer (in the direction of arrow G).

In the embodiment, the following description is regarding the reason for which the inclined guide surface 100a, i.e, the inclined surface of the guide member 100, is provided from the position of the center of the first conveyor screw 5 as illustrated in FIG. 7.

That is, in the embodiment, since the first conveyor screw 5 rotates in the clockwise direction, when the developer T is distant from the developing sleeve 8 further than the center of rotation (the rotation shaft 5a) of the first conveyor screw 5, the developer T is not thrown upward regardless of the rotation of the first conveyor screw 5. Accordingly, even though the inclined guide surface 100a is provided to be distant from the developing sleeve 8 further than the center of the first conveyor screw 5, the flown-off developer H does not collide with the inclined guide surface 100a, and thereby there is no actual gain.

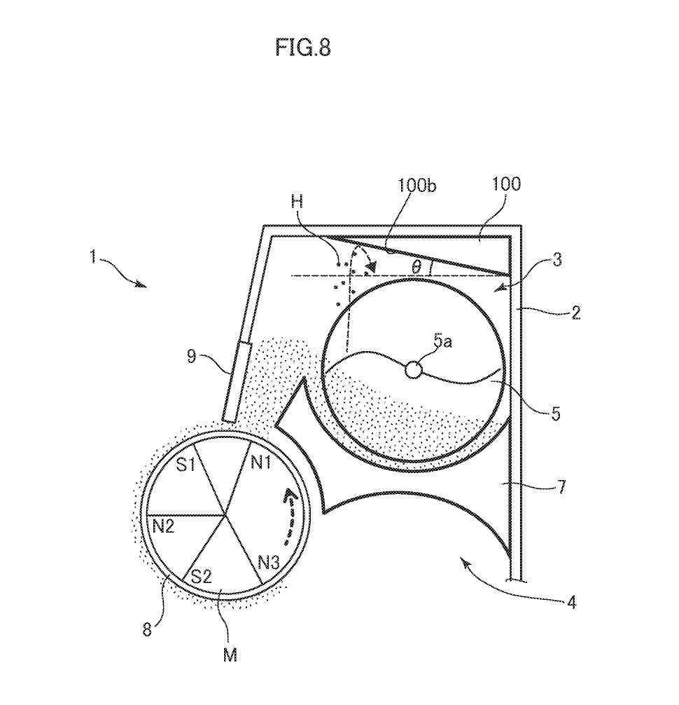

As illustrated in FIG. 8, when a guide surface 100b is provided in such a manner as to be inclined at the same inclined angle across the entire portion above the first conveyor screw 5, the guide surface 100b in the side close to the developing sleeve has to be separated by a large distance from the first conveyor screw 5. As a result, the thrown-upward and flown-off developer H may fall without collision with the guide surface 100b, and thereby this configuration is not preferable. In contrast, when the inclined angle θ is set to be small, the distance between the first conveyor screw 5 and the guide surface 100b is decreased, and the flown-off developer H can collide with the guide surface 100b; however, the angle θ is close to horizontal, thereby resulting in a decrease in the possibility of reflecting and supplying the flown-off developer H to the developing sleeve 8.

For the above-mentioned reason, in the embodiment, the incline (the inclined guide surface 100a) of the guide member 100 is provided to be closer to the developing sleeve 8 than the position of the center of the first conveyor screw 5.

### <Test Result 1>

Subsequently, a test illustrating the effects of the embodiment will be described.

The following Table 1 illustrates coating limits (grams) of the surface of the developing sleeve in the embodiment and the developing apparatus without the guide member 100 in the related art.

TABLE 1

| | Coating Limit [g] on the Surface |
|---|---|
| | of Developer Sleeve |
| Developing Unit | 290 |
| in the Related Art | |
| First Embodiment | 260 |

The coating limit g of the surface of the developing sleeve refers to the minimum amount of the developer in the developing case 2, which is required to ensure a successful coating on the surface of the developing sleeve 8. When the amount of developer T is less than the minimum amount in the developing case 2, a coating defect occurs, for example, a part of the surface of the developing sleeve 8 is not coated with the developer T. The coating limit of the surface of the developing sleeve is an index indicative of a defect of the coating of the surface of the developing sleeve, and typically, it is possible to measure the coating limit of the surface of the developing sleeve as follows.

While each of the developing sleeve 8, the first conveyor screw 5, and the second conveyor screw 6 is driven to rotate at a desired circumferential speed, the developing case 2 is gradually filled with the developer. As the amount of developer is increased in the developing case, the coating thickness of the surface of the developing sleeve 8 is gradually increased from an upstream side in a direction in which the first conveyor screw 5 circulates the developer, and in a short time, a desired thickness of the coating is formed on the entire surface of the developing sleeve. The amount of developer in the developing case 2 at this time is the coating limit of the surface of the developing sleeve, and it is possible to determine by measuring the weight of the developing apparatus 1.

According to Table 1, the developing apparatus in the related art requires the developer of the minimum of 290 g so as to ensure a successful coating on the surface of the developing sleeve, and in contrast, the developing apparatus 1 of the embodiment requires the developer of 260 g so as to ensure a successful coating on the developing sleeve 8. Table 1 illustrates the effects of the embodiment.

As described above, in the embodiment, the flown-off developer H originating from the rotation of the first conveyor screw 5 is effectively supplied to the developing sleeve 8 due to collision with the inclined guide surface 100a of the guide member 100. As a result, it is possible to provide the developing apparatus 1 that prevents occurrence of image defects originating from poor supply of the developer T to the developing sleeve 8.

In the embodiment, it is possible to effectively supply the developer T to the developing sleeve 8 even with a simple configuration in which the guide member 100 is disposed in the upper portion perpendicular to the first conveyor screw 5. Accordingly, it is possible to prevent occurrence of image defects originating from poor supply of the developer T to the developing sleeve 8 from the first conveyor screw 5.

### Second Embodiment

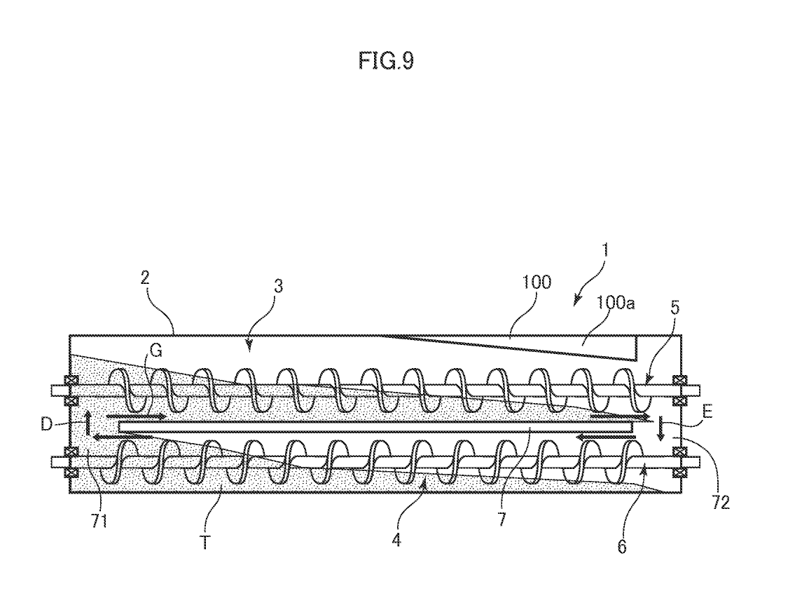

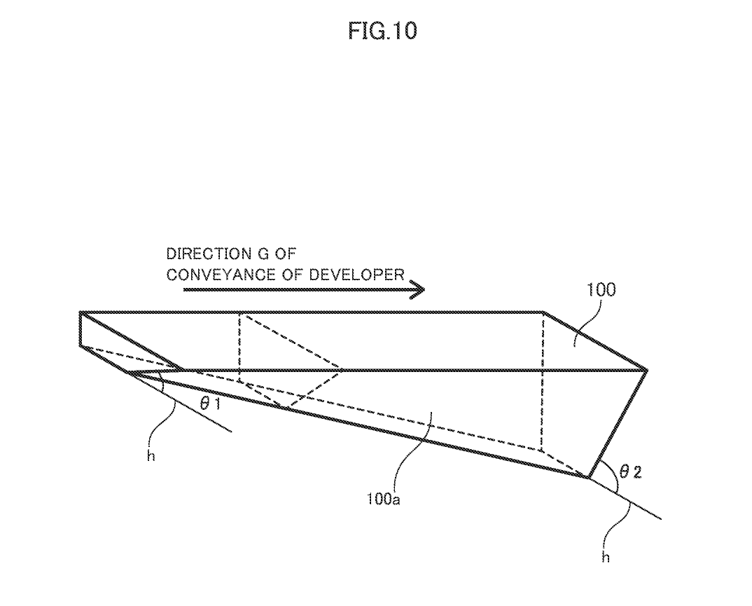

The following description given with reference to FIGS. 9 and 10 is regarding a second embodiment having a configuration in which the inclined angle of the inclined guide surface 100a of the guide member 100 is increased gradually. It is noted that since the embodiment has the same basic configuration as in the first embodiment, the same reference sign will be assigned to an element having a function or configuration which is substantially the same or equivalent to that in the first embodiment, the detailed description thereof will be omitted, and only specific configuration portions of the embodiment will be described in detail.

In the embodiment, as illustrated in FIGS. 9 and 10, the inclined guide surface 100a of the guide member 100 is configured such that the inclined angle of the inclined guide surface 100a is increased toward the downstream side in the direction (in the direction of arrow G) in which the first conveyor screw 5 conveys the developer. It is noted that FIG. 9 is a view illustrating the developing apparatus 1 when seen from a left side in FIG. 2, in which the developing sleeve 8 is not illustrated. FIG. 10 is a perspective view for depicting the shape of the guide member 100.

In the first embodiment, the angle θ of the inclined guide surface 100a is set to be evenly 20°; however, strictly speaking, even within the range of the guide member 100, the level of developer differs between the upstream side and the downstream side in the direction of conveyance. Accordingly, as in the embodiment, the inclined guide surface 100a on the downstream side is preferably set to have an inclined angle greater than on the upstream side.

In the embodiment, in FIG. 10, an angle (inclined angle) θ1 with respect to a horizontal plane h on the uppermost stream side in the direction of conveyance is set to be 5°, and an angle (inclined angle) θ2 with respect to the horizontal plane h on a downmost stream side is set to be 30°. As such, the inclined angle (θ2) of the inclined guide surface 100a with respect to the horizontal plane h on the downstream side is set to be greater than the inclined angle (θ1) with respect to the horizontal plane h on the upstream side in the direction in which the first conveyor screw 5 conveys the developer (in the direction of arrow G). In this configuration, even when the amount of developer is decreased on the downstream side in the direction (G) of conveyance of the developer as illustrated in FIG. 9, it is possible to efficiently guide a flown-off developer on the downstream side toward the limiting blade 9.

### <Test Result 2>

According to the results of tests performed on the configuration of the second embodiment, the developing apparatus in the related art requires the developer of the minimum of 290 g so as to ensure a successful coating on the surface of the developing sleeve, and in contrast, the developing apparatus 1 of the embodiment requires the developer of 250 g so as to ensure a successful coating on the surface of the developing sleeve 8. Table 2 illustrates the effects of the embodiment.

TABLE 2

| | Coating Limit [g] |
|---|---|
| | on the Surface |
| | of Developer Sleeve |
| Developing Unit | 290 |
| in the Related Art | |
| First Embodiment | 260 |
| Second | 250 |
| Embodiment | |

In the embodiment, a flown-off developer originating from the rotation of the first conveyor screw 5 is effectively supplied to the developing sleeve 8 due to collision with the inclined guide surface 100a. As a result, it is possible to provide the developing apparatus 1 that effectively prevents occurrence of image defects originating from poor supply of the developer T to the developing sleeve 8.

### Third Embodiment

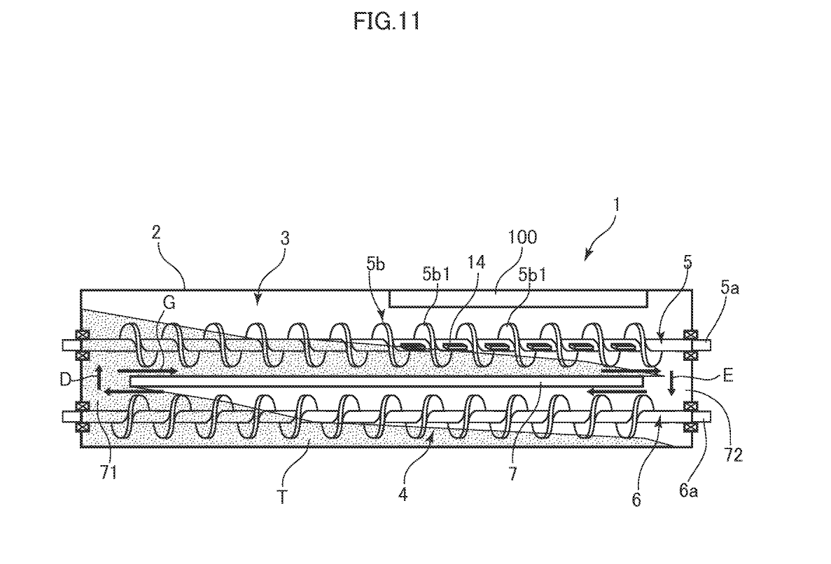

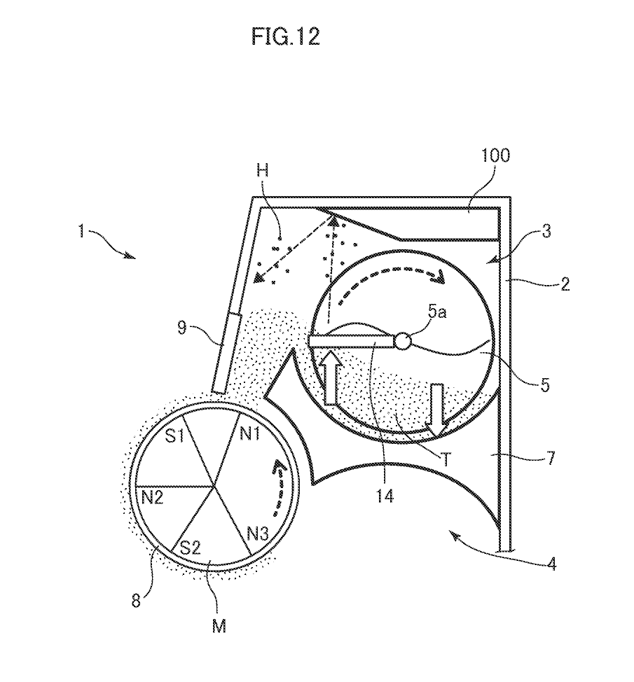

Subsequently, a third embodiment according to this disclosure will be described with reference to FIGS. 11 and 12. It is noted that since the embodiment has the same basic configuration as in the first embodiment, the same reference sign will be assigned to an element having a function or configuration which is substantially the same or equivalent to that in the first embodiment, the detailed description thereof will be omitted, and only specific configuration portions of the embodiment will be described in detail.

In the embodiment, as illustrated in FIG. 11, a rib member 14 is installed on the rotation shaft 5a of the first conveyor screw 5 in such a manner as to be positioned on the downstream side in the direction of conveyance. Here, the rib member 14 is a flat plate-like member attached to the rotation shaft 5a of the first conveyor screw 5.

That is, the rib member 14 is provided on the rotation shaft 5a of the first conveyor screw 5 in such a manner as to radially protrude between blade portions 5b1 of the agitating blade 5b. A plurality of the rib members 14 are provided at positions corresponding to an installation region of the guide member 100. That is, the flat plate-like rib members 14 are provided at the same angle between the blade portions 5b1 of the agitating blade 5b from a middle position in the axial direction of the rotation shaft 5a to the downstream side in the direction (G) of conveyance of the developer, and the flat plate-like rib members 14 protrude by the same length in the radial direction of the rotation shaft 5a. Each rib member 14 protrudes in the radial direction in such a manner that the rotation shaft 5a is included in a plane containing a surface of the rib member 14, which faces a direction of rotation (the clockwise direction in FIG. 12) of the first conveyor screw 5.

As a result, as illustrated in FIGS. 11 and 12, when the first conveyor screw 5 is driven to rotate, the developer T in contact with the rib member 14 receives a force in a normal direction with respect to the rib plane. For this reason, the developer T is conveyed only in the direction of rotation of the screw, and is not conveyed in the axial direction of the first conveyor screw 5. Accordingly, it is possible to more effectively throw the developer T to the limiting blade 9 even on the downstream side in the direction of conveyance of the developer (in the direction of arrow G).

That is, in the embodiment, the rib member 14 acts as a member for preventing the developer T from being conveyed to the downstream side. In this configuration, when the developer T is positioned on the downstream position of the first conveyor screw 5 on which the plurality of rib members 14 are disposed in the axial direction, the developer T at that position is unlikely to be further conveyed to a downstream side in the direction (G) of conveyance of the developer, and stagnates, and thereby the amount of developer is increased at the same position compared to when the rib member 14 is not provided.

As a result, it is possible to prevent a decrease in the amount of developer in the downstream portion of the first conveyor screw 5, and to stably supply the developer to the developing sleeve 8. In contrast, due to the addition of the rib member 14, the axial conveyance of the developer T in contact with the rib member 14 takes precedence over conveyance in other directions, and thereby the flown-off developer H in the direction of rotation of the first conveyor screw 5 is increased compared to when the rib member 14 is not provided. As such, it is possible to more effectively throw the developer T to the limiting blade 9 even on the downstream side in the direction of conveyance of the developer (in the direction of arrow G).

In the embodiment, the guide member 100 is provided in the portion above the first conveyor screw 5 similar to the first embodiment, the flown-off developer H is satisfactorily conveyed to the developing sleeve 8 due to collision with and reflection by the guide member 100. The reason is the same as that in the first embodiment, and thereby the description thereof will be omitted. Since the flown-off developer H thrown upward by the rib member 14 collides with the guide member 100, a longitudinal (the axial direction of the rotation shaft 5a) disposition region of the rib member 14 and a disposition region of the guide member 100 are set to be aligned as illustrated in FIG. 11.

### <Test Result 3>

Hereinafter, the results of tests performed on the configuration of the third embodiment will be illustrated.

Table 3 illustrates the effects of the embodiment.

That is, the developing apparatus (without the guide member 100 and the rib member 14) in the related art requires the developer of the minimum of 290 g so as to ensure a successful coating on the surface of the developing sleeve 8. A developing apparatus for comparison (without the guide member 100 and with the rib member 14) requires the developer of the minimum of 270 g so as to ensure a successful coating on the surface of the developing sleeve 8. In contrast, the developing apparatus 1 (with the guide member 100 and the rib member 14) according to the third embodiment, it is possible to ensure a successful coating on the surface of the developing sleeve 8 with the developer of at least 240 g.

TABLE 3

| | Coating Limit [g] |
|---|---|
| | on the Surface |
| | of Developer Sleeve |
| Developing Unit | 290 |
| in the Related Art | |
| Developing Unit | 270 |
| for Comparison | |
| Third Embodiment | 240 |

In the embodiment, since the rib member 14 is disposed in the downstream side of the first conveyor screw 5 in the direction of conveyance, and the guide member 100 is accordingly disposed, the flown-off developer H collides with the guide member 100, and then can be more effectively supplied to the developing sleeve 8. As a result, it is possible to provide the developing apparatus 1 that further prevents occurrence of image defects originating from poor supply of the developer to the developing sleeve 8.

### Fourth Embodiment

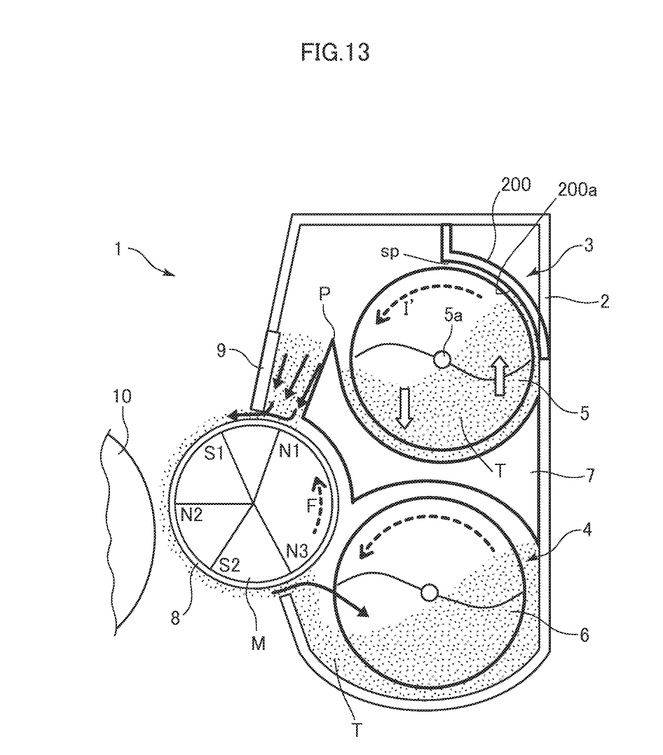

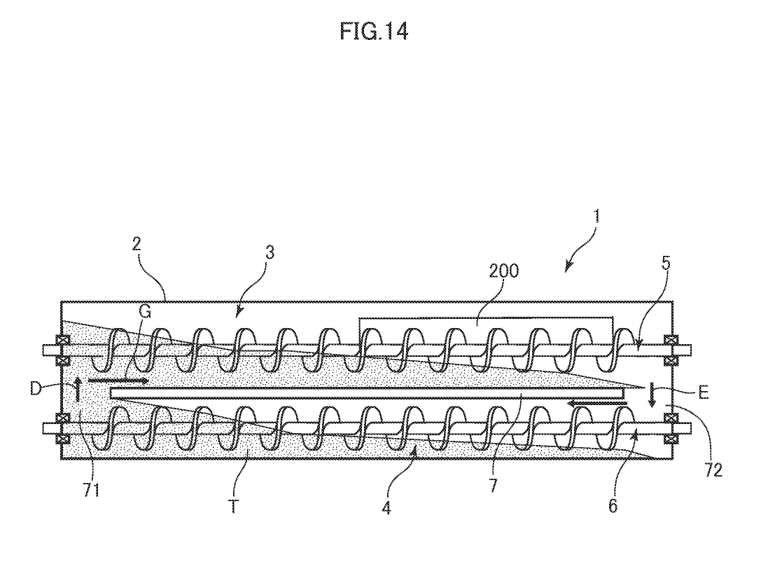

Subsequently, a fourth embodiment will be described with reference to FIGS. 13 and 14. It is noted that in the embodiment, a direction of rotation of the first conveyor screw 5 is set to be opposite (in a counter-clockwise direction) to that in the first to third embodiments. That is, in the embodiment, the first conveyor screw 5 is configured in such a manner as to rotate in a direction in which the developer is thrown (scraped) upward on the opposite side of the developing sleeve 8 with the rotation shaft 5a interposed between the developing sleeve 8 and the opposite side in the width direction. The fourth embodiment is different from the first embodiment in that instead of the provision of the guide member 100, a curved wall-shaped guide member 200 is provided in such a manner as to continuously extend along an outer circumference of the first conveyor screw 5, and the guide member 200 is opened on the side of the limiting blade 9. The embodiment has substantially the same basic configuration as the first embodiment.

That is, as illustrated in FIG. 13, the guide member 200 is disposed, which has a curved guide surface 200a that is curved continuously to an apex of the circular arc of the screw 5 along the outer circumference of the first conveyor screw 5. A portion of the guide member 200 close to the limiting blade 9 is opened so as to supply the developer T to the developing sleeve 8. The guide member 200 is provided between the developing case 2 and the first conveyor screw 5 on the opposite side from the developing sleeve 8 across at least the rotation shaft 5a of the first conveyor screw 5 in the width direction, and forms a guide path sp that guides the developer between the outer circumference of the first conveyor screw 5 and the guide member 200. The gap between the first conveyor screw 5 and the guide member 200 is set to be approximately 1 mm, and a direction of rotation of the first conveyor screw 5 is set to be the counter-clockwise direction (a direction of arrow I′). As described in the other embodiments, the guide member 200 according to the embodiment is disposed from the center region to the downstream side in the direction (in the direction of arrow G) in which the first conveyor screw 5 conveys the developer (refer to FIG. 14).

The agitating blade of the first conveyor screw 5 of the embodiment is formed in a spiral opposite to that of the first conveyor screw 5 in the first to third embodiments, and the direction of circulation (the direction (G) of conveyance of the developer) is the same as in the first to third embodiments. The second conveyor screw 6 of the agitation chamber 4 has the same configuration as that of the second conveyor screw 6 in the first to third embodiments, and a direction of rotation of the second conveyor screw 6 is also the counter-clockwise direction.

As illustrated in FIG. 13, in the embodiment, the direction of rotation (the direction of arrow I′) of the first conveyor screw (agitating conveyor screw) 5 is set to be the same as that (the direction of arrow F) of the developing sleeve (developer carrier) 8. The guide member 200 has the curved guide surface 200a configured to cover a part of the outer circumference of the first conveyor screw 5 along the outer circumference of the first conveyor screw 5 with the space sp formed between the first conveyor screw 5 and the guide member 200 and opening on a side of the limiting blade (layer thickness limiting member) 9. The developer T thrown upward by the rotating first conveyor screw 5 is guided toward the limiting blade 9 by the curved guide surface 200a of the guide member 200.

In the embodiment with this configuration, the developer T in contact with the first conveyor screw 5 receives a force in the direction (G) of conveyance of the developer, the developer T close to the developing sleeve 8 receives a perpendicular downward force, and the developer T distant from the developing sleeve 8 receives a perpendicular upward force. Accordingly, the developer is distributed in such a manner that the level of the developer distant from the developing sleeve 8 is high. Since the developer T having a high developer level and distant from the developing sleeve 8 is guided to the direction of the developing sleeve 8 by the curved guide surface 200a of the guide member 200, the developer T distant from the developing sleeve 8 is effectively supplied to the developing sleeve 8.

The following description is regarding the reason why the first conveyor screw 5 rotates in the counter-clockwise direction, and the guide member 200 is provided continuously to the apex of the circular arc of the first conveyor screw 5 along the outer circumference of the first conveyor screw 5.

That is, as described in the first to third embodiments, the rotation direction of the first conveyor screw 5 is set such that a developer level close to the developing sleeve 8 is high. As illustrated in FIG. 13, when an apex portion (a widthwise end portion of the partition wall close to the developing sleeve) P of the partition wall 7 is positioned to be higher than the shaft center of the first conveyor screw 5, and the first conveyor screw 5 rotates in the clockwise direction, the developer T close to the developing sleeve 8 is unlikely to be supplied to the developing sleeve 8 over the partition wall 7.

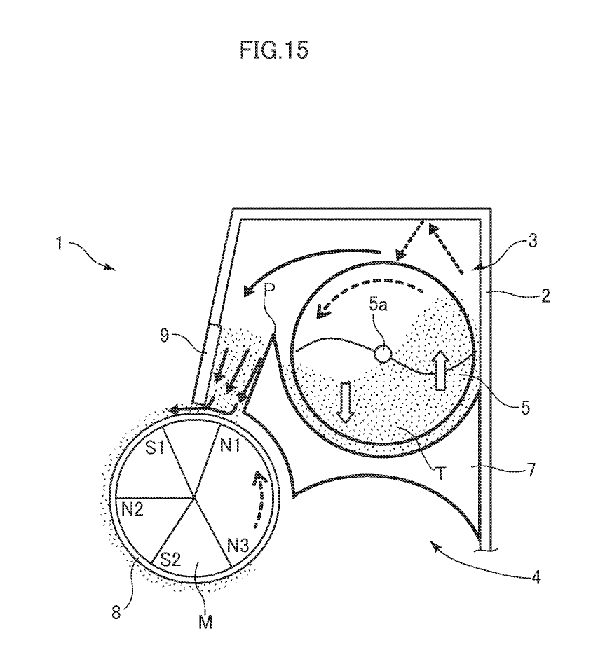

Here, as illustrated in FIG. 15, when the first conveyor screw rotates in the opposite direction (in the counter-clockwise direction), the developer T having a high developer level and distant from the developing sleeve 8 is thrown upward and supplied to the developing sleeve 8 over the apex portion P of the partition wall 7 by the screw 5. Accordingly, in the configuration of the embodiment, even when the apex portion P of the partition wall 7 is positioned to be higher than the shaft center of the first conveyor screw 5, it is possible to efficiently supply the developer to the developing sleeve 8.

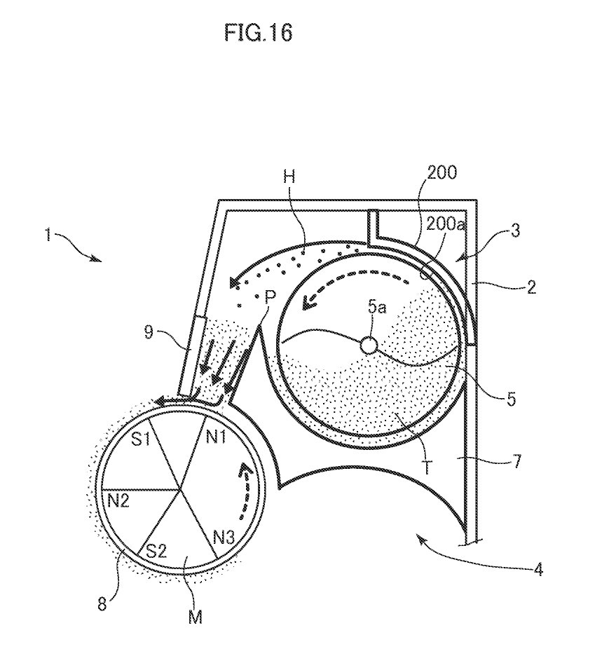

However, as illustrated in FIG. 15, in the configuration without the guide member 200, there may be the developer T present that strikes an upper portion of the developing case 2 due to being thrown upward by the first conveyor screw 5, and return to the first conveyor screw 5 without being supplied to the developing sleeve 8. As illustrated in FIGS. 13 and 16, since the guide member 200 is provided continuously to an upper side of the apex portion P of the circular arc of the partition wall 7 along the outer circumference of the first conveyor screw 5, it is possible to prevent the first conveyor screw 5 from throwing the developer upward, and guide the flown-off developer H to the direction of the developing sleeve. Accordingly, it is possible to more efficiently supply the developer to the developing sleeve 8.

### <Test Result 4>

Hereinafter, the results of tests performed on the configuration of the fourth embodiment will be illustrated.

Table 4 illustrates the effects of the fourth embodiment of this disclosure.

TABLE 4

| | Coating Limit [g] |
|---|---|
| | on the Surface |
| | of Developer Sleeve |
| Developing Unit | 340 |
| in the Related Art | |
| Developing Unit | 320 |
| in the Related Art | |
| Fourth | 290 |
| Embodiment | |
| Modification | 280 |
| Example 1 | |
| Modification | 270 |
| Example 2 | |

In the tested developing apparatus 1 according to the embodiment, the height of the apex portion P of the partition wall 7 is set to be 12.2 mm from the center (a reference point) of the developing sleeve 8, and the height of the center of the rotation shaft of the first conveyor screw 5 is set to be 8.2 mm. That is, in the embodiment, the apex portion P of the partition wall 7 is positioned to be higher than that of the first conveyor screw 5 by approximately 4 mm.

The rotation direction of the first conveyor screw 5 in the first to third embodiments is referred to as a first rotation direction, and the rotation direction of the first conveyor screw 5 in the embodiment is referred to as a second rotation direction. As described above, in the case where the rotation direction is the second rotation direction, the agitating blade of the first conveyor screw 5 is formed in an opposite spiral.

The developing apparatus (the developing apparatus not having the guide member 200 and having the first conveyor screw 5 rotating in the first rotation direction) in the related art requires the developer of the minimum of 340 g so as to ensure a successful coating on the surface of the developing sleeve. The developing apparatus (the developing apparatus not having the guide member 200 and having the first conveyor screw 5 rotating in the second rotation direction) in the related art requires the developer of the minimum of 320 g so as to ensure a successful coating on the surface of the developing sleeve 8. In contrast, the developing apparatus 1 (the developing apparatus having the guide member 200 and the first conveyor screw 5 rotating in the second rotation direction) according to the fourth embodiment requires the developer of 290 g so as to ensure a successful coating on the surface of the developing sleeve 8.

### Modification Example 1

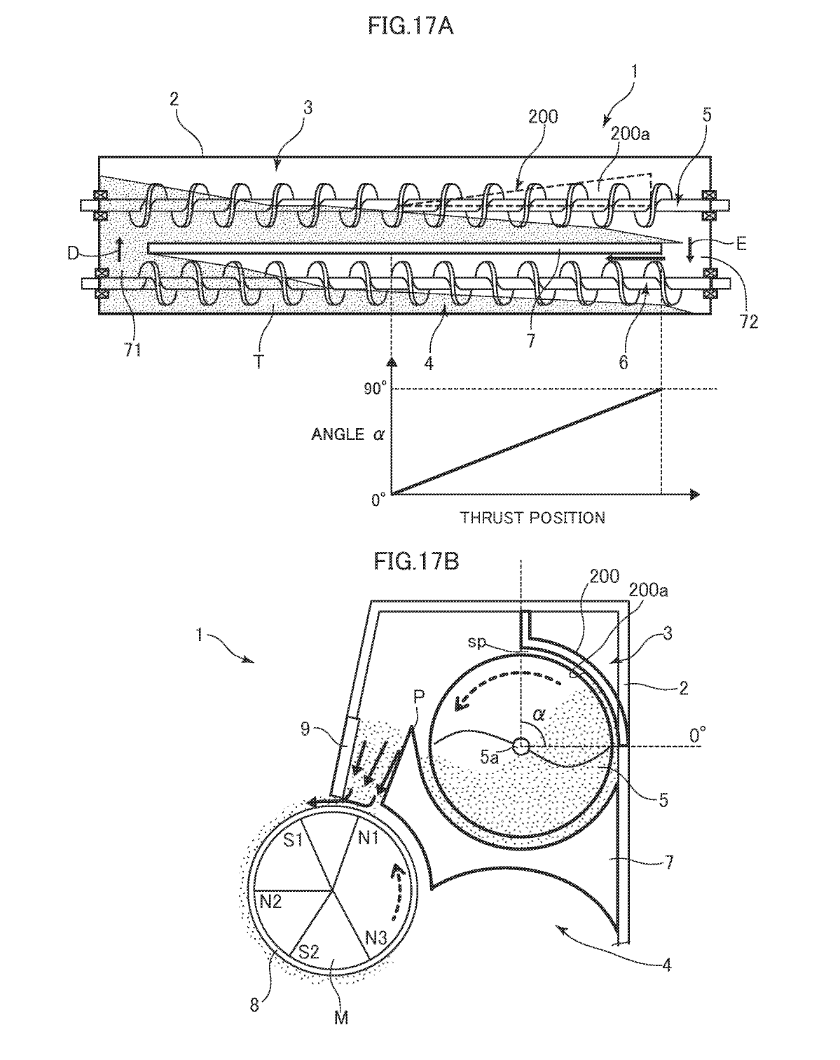

The following description given with reference to FIGS. 17A and 17B is regarding Modification Example 1 having a configuration in which the height of the guide member 200 increases toward the downstream side in the direction (G) in which the first conveyor screw 5 conveys the developer. It is noted that Modification Example 1 has the same basic configuration as in the first embodiment.

That is, in the fourth embodiment, the guide member 200 is provided up to the apex portion of the circular arc of the first conveyor screw 5 in such a manner as to have the same height from the center of the first conveyor screw 5, and strictly speaking, even across the guide member 200, the level of developer is inclined between the upstream side and the downstream side in the direction of conveyance. In Modification Example 1, the guide member 200 is configured such that the height of the curved guide surface 200a on the downstream side is higher than that on the upstream side.

Also, in Modification Example 1, the space sp between the curved guide surface 200a and the first conveyor screw 5 opens on the side of the limiting blade (layer thickness limiting member) 9. The curved guide surface 200a covers the outer circumference of the first conveyor screw 5 such that a range of covering the first conveyor screw 5 of the curved guide surface 200a is wider on a downstream side than an upstream side so that the opening gets closer to the limiting blade 9 in the direction in which the first conveyor screw 5 conveys the developer (in the direction of arrow G).

In Modification Example 1, when an angle of the circular arc of the first conveyor screw 5 is set to be α (with respect to the horizontal direction of 0°), the guide member 200 is configured such that the height of the curved guide surface 200a increases to the extent that a thrust position (axial position) approaches the downstream side in the direction of conveyance. In this configuration, as illustrated in FIG. 17A, even when the amount of developer is decreased on the downstream side in the direction (G) of conveyance of the developer, it is possible to efficiently guide a flown-off developer on the downstream side toward the limiting blade 9.

### <Test Result 5>

Table 4 illustrates the results of tests performed on the configuration of Modification Example 1. As understood from Table 4, in the developing apparatus 1 according to Modification Example 1, it is possible to ensure a successful coating on the surface of the developing sleeve 8 with the developer of 280 g.

### Modification Example 2

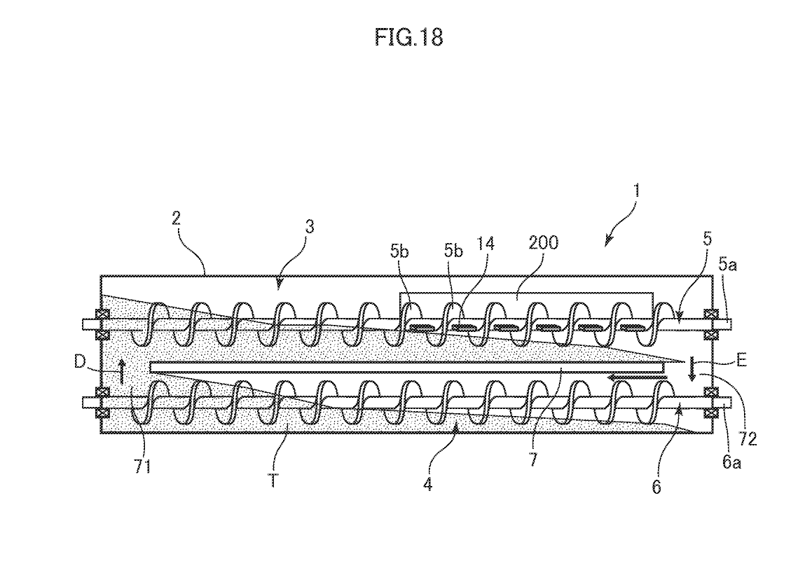

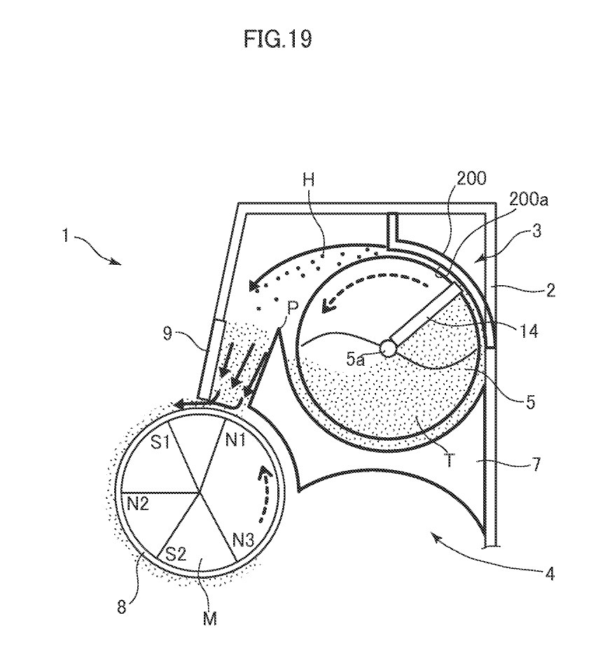

The following description given with reference to FIGS. 18 and 19 is regarding Modification Example 2 in which the rib member 14 is disposed in the downstream portion of the first conveyor screw 5 in the direction (G) of conveyance of the developer, and the guide member 200 is disposed so as to be aligned with the longitudinal disposition region of the rib member 14. It is noted that Modification Example 2 has the same basic configuration as in the first embodiment.

The rib member 14 is provided on the rotation shaft 5a of the first conveyor screw 5 in such a manner as to radially protrude between the blade portions of the agitating blade. A plurality of the rib members 14 are provided at positions corresponding to an installation region of the guide member 200. The flat plate-like rib members 14 are provided at the same angle between the agitating blades 5b from the middle position in the axial direction of the rotation shaft 5a to the downstream side in the direction (G) of conveyance of the developer, and the flat plate-like rib members 14 protrude by the same length in the radial direction of the rotation shaft 5a. The rib member 14 protrudes in the radial direction in such a manner that the rotation shaft 5a is included in a plane containing the surface of the rib member 14, which faces the direction of rotation (the clockwise direction in FIG. 19) of the first conveyor screw 5.

As a result, as illustrated in FIGS. 18 and 19, when the first conveyor screw 5 is driven to rotate, the developer T in contact with the rib member 14 receives a force in the normal direction with respect to the rib plane. For this reason, the developer T is conveyed only in the direction of rotation of the screw, and is not conveyed in the axial direction of the first conveyor screw 5. Accordingly, it is possible to more effectively fly the developer T to the limiting blade 9 even on the downstream side in the direction of conveyance of the developer (in the direction of arrow G).

### <Test Result 6>

Table 4 illustrates the results of tests performed on the configuration of Modification Example 2.

As understood from Table 4, in the developing apparatus 1 according to Modification Example 2, it is possible to ensure a successful coating on the surface of the developing sleeve 8 with the developer of 270 g.

As described above, in Modification Example 2, even when the apex portion P of the partition wall 7 is positioned to be higher than the center of the rotation shaft 5a of the first conveyor screw 5, it is possible to efficiently supply the developer to the developing sleeve 8. As a result, it is possible to provide the developing apparatus 1 that prevents occurrence of image defects originating from poor supply of the developer T to the developing sleeve 8.

While this disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-030599, filed Feb. 20, 2014, which is hereby incorporated by reference herein in its entirety.

What is claimed is:

1. A developing apparatus comprising:
a developer carrier configured to rotate while carrying a developer containing toner and carriers;
a first chamber configured to supply the developer to the developer carrier;
a layer thickness limiting member configured to limit the layer thickness of the developer supplied from the first chamber and carried by the developer carrier;
a second chamber configured to communicate with the first chamber and to collect the developer from the developer carrier;
an agitating conveyor screw provided parallely with the developer carrier in the first chamber such that an axial direction of a rotation shaft of the agitating conveyor screw is parallel to a rotation shaft of the developer carrier and a position of the agitating conveyor screw is shifted from that of the developer carrier in a width direction orthogonal to the axial direction, the agitating conveyor screw includes an agitating blade spirally extending in the axial direction to convey the developer in the axial direction while agitating the developer in the first chamber; and
a guide member disposed above the agitating conveyor screw in the first chamber and configured to guide a developer thrown by the rotating agitating conveyor screw toward the layer thickness limiting member.

2. The developing apparatus according to claim 1, wherein the first and second chamber are disposed in a vertical direction, and
the developer carrier is disposed such that the rotation shaft of the developer carrier is positioned below the rotation shaft of the agitating conveyor screw in the vertical direction.

3. The developing apparatus according to claim 1, wherein the agitating conveyor screw is configured such that a rotation direction of the agitating conveyor screw is opposite to that of the developer carrier, and
wherein the guide member has an inclined guide surface inclined upward to face in a direction of the layer thickness limiting member and configured to rebound and guide a developer thrown upward by the rotating agitating conveyor screw toward the layer thickness limiting member.

4. The developing apparatus according to claim 3, wherein the inclined guide surface is inclined toward the layer thickness limiting member from a position closer to the layer thickness limiting member than the rotation shaft of the agitating conveyor screw in the width direction.

5. The developing apparatus according to claim 3, wherein an inclined angle of the inclined guide surface with respect to a horizontal plane on a downstream side is set to be greater than that of the inclined guide surface on an upstream side in a direction in which the agitating conveyor screw conveys the developer.

6. The developing apparatus according to claim 1, wherein the agitating conveyor screw is configured such that a rotation direction is the same as that of the developer carrier, and
wherein the guide member has a curved guide surface configured to cover a part of an outer circumference of the agitating conveyor screw with a space formed between the agitating conveyor screw and the guide member and opening on a side of the layer thickness limiting member, and
wherein the developer thrown upward by the rotating agitating conveyor screw is guided toward the layer thickness limiting member by the curved guide surface.

7. The developing apparatus according to claim 6, wherein a range of covering the agitating conveyor screw of the curved guide surface is wider on a downstream side than an upstream side so that the opening gets closer to the layer thickness limiting member in a direction in which the agitating conveyor screw conveys the developer.

8. The developing apparatus according to claim 1, wherein the guide member is formed from a center region to a downstream side in a direction in which the agitating conveyor screw conveys the developer.

9. The developing apparatus according to claim 1, wherein a rib member is provided on the rotation shaft of the agitating conveyor screw such a manner as to radially protrude between blade portions of the agitating blade.

10. The developing apparatus according to claim 9, wherein the rib member is provided plurally at positions corresponding to an installation region of the guide member.

11. A developing apparatus comprising:
a developing case with an opening portion;
a developing sleeve rotatably supported such that a part of an outer circumference of the developing sleeve is exposed to an outside of the developing case from the opening portion of the developing case;
a supply conveyor screw provided parallely with the developing sleeve, in a width direction orthogonal to an axial direction of a rotation shaft of the supply conveyor screw, in the developing case such that the axial direction of the rotation shaft of the supply conveyor screw is parallel to a rotation shaft of the developing sleeve, the supply conveyor screw includes an agitating blade spirally extending in its axial direction and configured to supply a developer in the developing case to the developing sleeve while conveying the developer in the axial direction by the rotation of the supply conveyor screw; and
a guide member disposed above the supply conveyor screw and configured to guide the developer conveyed by the supply conveyor screw toward the developing sleeve.

12. The developing apparatus according to claim 11, wherein the supply conveyor screw is provided such that the rotation shaft of the supply conveyor screw is positioned above the rotation shaft of the developing sleeve and is configured to rotate in a direction in which the developer is thrown upward on the side of the developing sleeve in the width direction, and
wherein the guide member has an inclined surface inclined such that a thickness of the guide member is decreased from the supply conveyor screw side toward the developing sleeve side in the width direction.

13. The developing apparatus according to claim 12, wherein the inclined surface of the guide member is provided to be closer to the developing sleeve than the rotation shaft of the supply conveyor screw in the width direction.

14. The developing apparatus according to claim 13, wherein the guide member is provided in a region on a side opposite to the developing sleeve in the width direction across a position of an widthwise end portion, close to the developing sleeve, of the supply conveyor screw.

15. The developing apparatus according to claim 11, wherein the supply conveyor screw is provided such that the rotation shaft of the supply conveyor screw is positioned above the rotation shaft of the developing sleeve and is configured to rotate in a direction in which the developer is thrown upward on an opposite side from the developing sleeve across its rotation shaft in the width direction, and
wherein the guide member provided between the developing case and the supply conveyor screw on the opposite side from the developing sleeve across the rotation shaft of the supply conveyor screw in the width direction and forms a guide path guiding the developer between an outer circumference of the supply conveyor screw and the guide member.

16. The developing apparatus according to claim 15, further comprising:
a circulating conveyor screw provided in the developing case such that an axial direction of a rotation shaft is parallel to the rotation shaft of the supply conveyor screw,
wherein the developing case includes a partition wall configured to partition an inner space of the developing case into an upper region and a lower region in a vertical direction, and
wherein the supply conveyor screw is provided above the partition wall, and the circulating conveyor screw is provided below the supply conveyor screw while the partition wall being interposed therebetween and collects and circulates the developer that is conveyed by the supply conveyor screw and falls downward.

17. The developing apparatus according to claim 16, wherein an end portion of the partition wall close to the developing sleeve in the width direction is positioned to be higher than the rotation shaft of the supply conveyor screw.

18. The developing apparatus according to claim 11, wherein the guide member is provided downstream of a center portion of the supply conveyor screw in a direction of conveyance of the developer.
